(19) United States
(12) Patent Application Publication
(10) Pub. No.: US 2012/0214002 A1
(43) Pub. Date: Aug. 23, 2012

(54) ONE-PACK TYPE LIQUID EPOXY RESIN COMPOSITION AND ADHESION METHOD USING SAME

(76) Inventors: Takahiro Kasahara, Tokyo (JP); Akito Muramatsu, Tokyo (JP)

(21) Appl. No.: 13/502,771

(22) PCT Filed: Nov. 5, 2010
(86) PCT No.: PCT/US10/55544

§ 371 Date: Apr. 19, 2012

(30) Foreign Application Priority Data
Nov. 10, 2009 (JP) 2009-257126

(51) Int. Cl. C09J 163/08; B32B 37/12; B32B 27/38

(52) U.S. Cl. 428/414; 523/400; 523/440; 156/330

(57) ABSTRACT

The present disclosure provides an epoxy resin composition that has storage stability and allows the formation of cured products having flexibility. The epoxy resin composition is a one-pack type liquid epoxy resin composition comprising a polyfunctional linear epoxy resin having an epoxy equivalent of 400 or more, a tetrabasic acid anhydride having a melting point of 10° C. or higher, and an organic metal compound.

### TECHNICAL FIELD

The present disclosure relates to a one-pack type liquid epoxy resin composition that has storage stability, an epoxy resin adhesive composition, an article adhered using the same, and an adhesion method using the same.

### BACKGROUND

Epoxy resin compositions have conventionally been commonly used as adhesives, sealing materials and the like, and technical advances have been achieved by, for example, raising glass transition temperature (Tg) and lowering coefficient of thermal expansion (CTE). However, in the fields of electricity and electronics, in the case of adhering motor magnets or fixing ferrite for transformer, adhesives composed of ordinary epoxy resin compositions have had problems involving cracking of an adhered material due to the thin and small size of such adhered materials. There has recently been a need for adhesives offering greater flexibility, which differs from the conventional technical requirements of epoxy adhesives. Typical examples of such required properties include a low Tg and high elongation percentage, while a low halogen content is also required in transformer applications in addition to these requirements.

Examples of adhesives having such properties include silicone-modified mixtures as represented by moisture-curable adhesives and addition-cured silicone adhesives. In addition, Japanese Unexamined Patent Publication (Kokai) No. 2007-106852 describes a heat-curable composition containing a bisphenol-polysiloxane polymer having epoxy groups, a heat latent curing agent and the like, and such a composition is described to have flexibility.

Japanese Unexamined Patent Publication (Kokai) No. 7-33837 describes a polymerizable resin composition that does not contain silicone in the form of a photocurable resin composition containing a polybutadiene-based resin having polymerizable ethylenic unsaturated double bonds in a terminal and/or side chain thereof and a photopolymerization initiator.

U.S. Pat. No. 6,346,330 describes an epoxy resin composition having superior flexibility that is used in a form-in-place (FIP) gasket.

### SUMMARY OF THE INVENTION

There is a demand for an epoxy resin composition that has improved storage stability so as to enable cold storage (such as storage at 5 to 10° C.) while also allowing the formation of cured products having flexibility. The present disclosure provides an epoxy resin composition provided with such properties.

According to one aspect thereof, the present disclosure provides a one-pack type liquid epoxy resin composition, comprising: a polyfunctional linear epoxy resin having an epoxy equivalent of 400 or more, a tetrabasic acid anhydride having a melting point of 10° C. or higher, and an organic metal compound.

A polyfunctional linear epoxy resin having an epoxy equivalent of 400 or more (to also be simply referred to as a “polyfunctional linear epoxy resin”) is a compound having a linear hydrocarbon chain in the main chain thereof and having two or more epoxy rings. The polyfunctional linear epoxy resin has for the main chain thereof a unit derived from a polymerizable hydrocarbon compound having carbon-carbon unsaturated bonds such as double bonds or triple bonds and has two or more epoxy rings. More specifically, the polyfunctional linear epoxy resin can be obtained by epoxidating double bonds within a linear unsaturated hydrocarbon chain. Epoxidation of the double bonds is normally carried out with a peracid such as peracetic acid, or a peroxide such as hydrogen peroxide. Differing from typical production processes using epichlorhydrin, the content of chlorine in the resin can be reduced. The polyfunctional linear epoxy resin is obtained by epoxidating double bonds within the chain of a homopolymer of a diene such as butadiene or isoprene or a copolymer of a diene and an alkene such as ethylene. Since the polyfunctional linear epoxy resin has a linear hydrocarbon chain, flexibility is imparted to the resulting cured product. The epoxy equivalent of the polyfunctional linear epoxy resin is 400 or more, 450 or more or 500 or more. This is because such a comparatively high epoxy equivalent causes the hydrocarbon chain composing the main chain to become longer enabling the cured product to demonstrate elastomer properties. The polyfunctional epoxy resin can also have an epoxy equivalent of 2000 or less, 1500 or less, 800 or less, or 650 or less. In the case the epoxy equivalent is excessively large, crosslinking density decreases, heat resistance decreases or coefficient of thermal expansion increases. Incidentally, “epoxy equivalent” refers to the number of grams of resin containing 1 gram equivalent of epoxy groups (g/eq), and is measured in accordance with JIS K 7237.

An example of a useful polyfunctional linear epoxy resin is L207 (trade name) (available from Kuraray Co., Ltd.). L207 is a polymer that is obtained by partially hydrogenating a butadiene-isoprene polymer followed by epoxidating the residual double bonds with a peracid, has terminal hydroxyl groups, and has an epoxy equivalent of 590.

The epoxy resin composition contains a curing agent for curing the epoxy resin in the form of a tetrabasic acid anhydride having a melting point of 10° C. or higher. Differing from conventional acid anhydride curing agents that are liquids at a temperature of 10° C. or higher, this acid anhydride curing agent is a solid at a temperature of 10° C. or higher, thereby making it possible to improve storage stability of even one-pack type liquid epoxy resin compositions by inhibiting the reaction with the polyfunctional linear epoxy resin at low temperatures. In addition, the use of a tetrabasic acid anhydride for the acid anhydride makes it possible to increase crosslinking density of a cured product in comparison with typical dibasic acid anhydrides. The melting point of the acid anhydride is 10° C. or higher, and for example, 20° C. or higher or 40° C. or higher.

Examples of acid anhydrides that can be used for the curing agent include methylcyclohexene tetracarboxylic acid dianhydride (5-(2,5-dioxotetrahydrofuran-3-yl)-3-methyl-3-cyclohexene-1,2-dicarboxylic acid anhydride) (B-4400) (melting point: 165° C.) represented by the following formula:

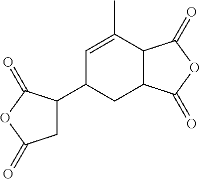

ethylene glycol bisanhydrotrimellitate (TMEG-600) (melting point: 170° C.) represented by the following formula:

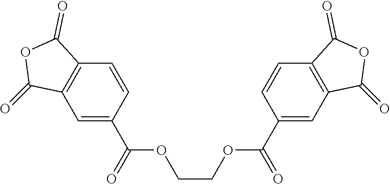

glycerin bisanhydrotrimellitate monoacetate (melting point: 65-85° C.) represented by the following formula:

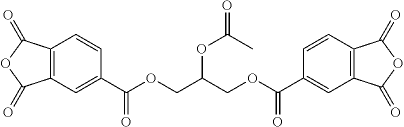

1,3,3a,4,5,9b-hexahydro-5(tetrahydro-2,5-dioxo-3-furanyl)naphtho[1,2-c]furan-1,3-dione (melting point: 198° C. or higher) represented by the following formula:

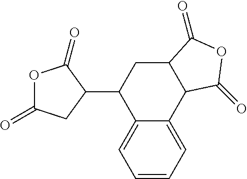

3,3′,4,4′-diphenylsulfolane tetracarboxylic acid dianhydride (melting point: 287° C. or higher) represented by the following formula:

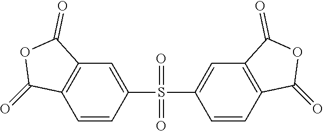

and, 1,2,3,4-butane tetracarboxylic acid dianhydride (melting point: 260° C. or higher) represented by the following formula.

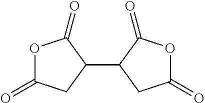

In order to ensure adequate curing, the acid anhydride curing agent can normally be contained in the epoxy resin composition at 10 to 50 parts by weight based on 100 parts by weight of the polyfunctional linear epoxy resin.

Incidentally, “melting point of acid anhydride” is measured in accordance with JIS K 0064.

In addition to the tetrabasic acid anhydride curing agent, the epoxy resin composition contains a curing accelerator for accelerating curing by the curing agent. The curing accelerator is an organic metal compound having a function of a Lewis acid such as an organic zinc compound or organic aluminum compound. Specific examples of the organic metal compound that can be used include organic zinc compounds such as zinc stearate, zinc 2-ethylhexanoate or zinc acetyl acetonate and organic aluminum compounds such as aluminum acetyl acetonate. The organic metal compound can normally be contained in the epoxy resin composition at 0.5 to 10 parts by weight based on 100 parts by weight of the polyfunctional linear epoxy resin.

The epoxy resin composition may also contain a reactive diluent as necessary. A reactive diluent is used to lower the viscosity of the epoxy resin composition, and normally a low-viscosity monofunctional or bifunctional epoxy resin or oxetane resin is used that contains one or two epoxy groups in a molecule thereof. More specifically, the reactive diluent is an epoxy resin having an epoxidated terminal of a long-chain alkyl group of a dimer of a long-chain fatty acid in the form of a dimer acid, examples of which include a monofunctional epoxy resin or oxetane resin having a long-chain alkyl group and an epoxidated polybutadiene. An example of a commercially available dimer acid diglycidyl ester is YD-171 (trade name) (epoxy equivalent: 390 to 470) (available from Tohto Kasei Co., Ltd.). In addition, examples of commercially available monofunctional epoxy resins having a long-chain alkyl group are Vikolox 12 (trade name) (available from

Kitamura Chemicals Co., Ltd.) and DY-A (trade name) (available from Huntsman Japan K.K.), an example of a monofunctional oxetane resin is OXT-212 (trade name) (available from Toagosei Co., Ltd.), and an example of a commercially available epoxidated polybutadiene is Denarex R-45EPT (trade name) (glycidyl ether-terminated polybutadiene, epoxy equivalent: 1570) (Nagase Chemtex Corp.). Moreover, dimer acids in which the terminal has been modified to an alcohol can also be used as diluents. A commercially available example of these diluents is Pripol 2023 (trade name) (available from Croda Japan K.K.). The diluent can normally be contained in the epoxy resin composition at 100 parts by weight or less based on 100 parts by weight of the polyfunctional linear epoxy resin.

The epoxy resin composition may also further contain inorganic filler in order to effectively improve the cohesive strength of a cured product of the epoxy resin composition and obtain superior adhesive strength. The inorganic filler consists of particles of metal oxides such as alumina, silica or ferrite, a powder of a metal such as aluminum, silver or nickel. The inorganic filler is preferably submicron particles having a particle diameter of less than 1 micrometer (μm). The use of such particles makes it possible to improve initial adhesive strength and high-temperature adhesive strength after curing. On the other hand, the particle diameter of the inorganic filler preferably exceeds about 20 nanometers (nm). This is because, if the particle diameter of the inorganic filler is excessively small, the inorganic filler causes a significant increase in the viscosity of the composition prior to curing. The particle diameter of the inorganic filler is, for example, 20 to 900 nm. Examples of useful commercially available inorganic fillers include UFP-30 (particle diameter: 99 nm) and UFP-80 (particle diameter: 34 nm) (fine silica particles, available from Denka Co., Ltd.).

Incidentally, “particle diameter of inorganic filler” refers to the median diameter based on the particle size distribution as determined by light scattering. Particle size distribution as determined by light scattering refers to the particle size distribution determined by measuring the amount of scattered light and the number of occurrences thereof under conditions for which the relationship with the amount of scattered light is known based on light scattering phenomena that occurs when light contacts fine particles suspended in a fluid, or refers to the particle size distribution determined by measuring a diffraction pattern based on a change in the diffraction pattern of laser light caused by fine particles due to the size of the particles. The median diameter (d50) refers to the particle diameter when the number of particles larger than a certain particle diameter accounts for 50% of all particles in the particle size distribution of the particles.

The amount of inorganic filler is determined based on such factor as the viscosity of the epoxy resin composition and the physical properties required of cured products obtained from the epoxy resin composition. The amount of inorganic filler contained in the epoxy resin composition is normally 80 parts by weight or less based on 100 parts by weight of the polyfunctional epoxy resin, and for example, is 20 to 80 parts by weight based on 100 parts by weight of the polyfunctional epoxy resin. If the amount of inorganic filler is excessively low, the effect of improving the adhesive strength of the resulting cured product may be inadequate, while if the amount is excessively large, the viscosity of the composition becomes excessively high which may make coating difficult.

The epoxy resin composition may further contain a silane coupling agent to improve adhesive strength. Although examples of silane coupling agents that can be used include epoxy-based, amino-based and thiol-based silane coupling agents, epoxy-based silane coupling agents are preferable from the viewpoint of stable viscosity of the composition.

In the case the viscosity of the epoxy resin composition is high, a mineral oil-based antifoaming agent may be added to improve the efficiency of degassing work during production of the composition.

Since the epoxy resin composition uses for the curing agent thereof a tetrabasic acid anhydride having a melting point of 10° C. or higher, storage stability is high even in the case of a one-pack type liquid epoxy resin composition. As a result, storage life at 10° C. or higher, and particularly at room temperature (20° C.), can be made to be 1 month or more, while storage life at 40° C. can be made to be about 2 weeks. Such a composition has a storage life of 1 year or more in the case of cold storage. In the present specification, “storage life” is used in the same context as workable period, and refers to the time until viscosity reaches twice the value of initial viscosity.

The epoxy resin composition can be used as an adhesive composition for adhering two objects, or as a sealing material for filling in gaps between objects. More specifically, a composition containing the epoxy resin composition is used as an adhesive composition by coating in the form of a one-pack liquid composition onto a first substrate, joining with a second substrate before curing, and then curing the composition. Alternatively, a composition containing the epoxy resin composition is used as a sealing material by filling in the form of a one-pack liquid composition into a gap between objects and then curing the composition. Curing of the composition is carried out by heating, and curing can be carried out at 120 to 180° C. for 30 to 120 minutes.

According to one aspect thereof, the present disclosure provides an article in which a brittle material is adhered to an adhered material by means of a cured product of an epoxy adhesive composition containing the epoxy resin composition of the present disclosure. Here, an example of a brittle material is a sintered body, while an example of an adhered material is a metal member or sintered body. Incidentally, a “brittle material” is a material which causes failure (shattering or cracking) when it is subjected to JIS R 3206 method.

According to another aspect thereof, the present disclosure also provides a method for producing an adhered article comprising coating an epoxy adhesive composition containing the epoxy resin composition of the present disclosure onto a brittle material or adhered material, joining the brittle material and the adhered material by means of the epoxy adhesive composition, and curing the epoxy adhesive composition.

As has been described above, since an adhesive composition containing the epoxy resin composition of the present disclosure imparts flexibility to a cured product thereof, it can be advantageously used to adhere brittle materials. Examples of specific useful applications of the aforementioned adhesive composition include an adhesive for fixing motor magnets, and an adhesive for fixing ferrite for transformer. Although the adhered portions of motor magnets and ferrite for transformer tend to be subjected to stress and crack easily, cracking can be prevented since an adhesive based on the epoxy resin composition of the present disclosure has flexibility. In addition, although motor magnets in particular are presumed to be used at high temperatures of about 120° C., the containing of an inorganic filler in the composition makes it possible to maintain adhesive strength even at high temperatures.

Examples of brittle materials in the production method of an adhered product described above include sintered bodies, various types of magnets such as neodymium magnets, samarium cobalt magnets or ferrite magnets, various types of ferrite for transformer such as MnZn ferrite, and ultrasonic vibrators. Examples of adhered materials include metals such as steel and sintered bodies such as inorganic metal oxides.

In addition, in the case of fixing motor magnets, magnets composed of sintered bodies constitute the brittle material, while a rotor motor composed of a metal such as steel constitutes the adhered material. In addition, in the production of a transformer core such as an EI core, E-shaped ferrite (sintered body) constitutes the brittle material, while I-shaped ferrite (sintered body) constitutes the adhered material.

Moreover, since a cured product of the epoxy resin composition has the properties of an elastomer, it can be used as a vibration absorber.

### EXAMPLES

The following provides a more detailed explanation of the invention of the present disclosure based on examples thereof. The invention of the present disclosure is not limited to the indicated examples.

### Example 1

A one-pack type liquid epoxy resin composition was produced by mixing 100 parts by weight of L207 (trade name) (epoxidated polymer obtained by partially hydrogenating butadiene-isoprene polymer followed by epoxidating the residual double bonds with peracid, epoxy equivalent: 590, available from Kuraray Co., Ltd.) as a polyfunctional linear epoxy resin, 25 parts by weight of YD-171 (trade name) (dimer acid glycidyl ester, epoxy equivalent=390-470), 12.5 parts by weight of OXT-212 (trade name) (monofunctional oxetane resin, available from Toagosei Co., Ltd.) and 25 parts by weight of Pripol 2023 (trade name) (dimer diol, available from Croda Japan K.K.) as reactive diluents, 30 parts by weight of B-4400 (trade name) (available from DIC Corp.) as a tetrabasic acid anhydride, 2.5 parts by weight of zinc stearate as a curing accelerator, 50 parts by weight of UFP-80 (particle diameter: 34 nm) (fine silica particles, available from

Denka Co., Ltd.) as an inorganic filler, and 2.5 parts by weight of A-187 (trade name) (available from Dow Corning Toray Co., Ltd.) as a silane coupling agent.

### Description of Testing

### 1. Workable Period

The viscosity (initial viscosity) of the resulting one-pack type liquid epoxy resin composition was measured at a temperature of 40° C. followed by measuring viscosity after storing at 40° C. Viscosity was measured with a viscometer manufactured by Haake Medingen GmbH under conditions of a shear rate of 200 s⁻¹.

The initial viscosity was 90 Pa·s. The amount of time until the viscosity reached a value equal to twice the initial viscosity was defined as the workable period, and the workable period was determined to be 2 weeks.

### 2. Cured Product Glass Transition Temperature (Tg)

The resulting one-pack type liquid epoxy resin composition was cured for 1 hour at 150° C. The glass transition temperature (Tg) of the resulting cured product was then measured. Tg was measured with a dynamic viscoelasticity measuring apparatus by plotting tans, defined as storage elastic modulus (G′)/loss elastic modulus (G″), while applying stress at a stress frequency of 10 Hz in tension mode and raising the temperature at the rate of 4° C./min, and using the peak temperature thereof to be the glass transition temperature (Tg). Tg was determined to be 10° C.

### 3. Elongation Percentage

A piece of a cured product measuring 1 mm thick×5 cm×5 mm was prepared from the resulting one-pack type liquid epoxy resin composition. The curing conditions consisted of 1 hour at 150° C. The test piece was stretched until it broke at a pulling rate of 50 mm/min with a tensile tester followed by measurement of elongation of the test piece at that time. Elongation rate was determined as (movement distance of jig when the cured product broke)/(initial distance between jigs of the tensile tester)×100(%). The elongation percentage was determined to be 170%.

### 4. Shear Adhesive Strength Test

An adhesive composed of an epoxy resin composition was arranged between two aluminum sheets (2024) (25 mm wide×100 mm long×1.6 mm thick) followed by measuring of shear adhesive strength. Masking tape of a thickness such that the thickness of the adhesive was 0.1 mm was arranged so as to surround a surface area of 25 mm×12.5 mm and the adhesive was applied followed by fixing in place with paper clips and curing for 1 hour at 150° C. Adhesive strength was then measured at a pulling rate of 0.5 mm/min for a sample having a thickness of 0.1 mm at an adhesive with adhered area of 25 mm×12.5 mm. Adhesive strength was measured at 25° C. and 120° C. The shear adhesive strength at 25° C. was 4.8 MPa while that at 120° C. was 2.2 MPa.

### 5. Pressure Cooker Test

A test piece as described in the aforementioned shear adhesive strength test was deteriorated with a pressure cooker for 24 hours under conditions of saturated vapor pressure at a temperature of 134° C., pressure of 3 atm and 100% relative humidity (RH) followed by measurement of shear adhesive strength after deterioration in the same manner as described in the aforementioned shear adhesive strength test. The test was carried out at 25° C. As a result, the shear adhesive strength was determined to be 6.3 MPa.

### 6. Total Chlorine Content

Total chlorine content was measured according to the combustion method in compliance with JPCA-ES01 (Test Method for Halogen-Free Copper Clad Laminates). As a result, the chlorine content was determined to be less than 500 ppm.

### 7. Sintered Body Adhesive Strength Test

A ferrite sintered body measuring 2 cm×2 cm×5 mm was adhered to be metal plate (steel plate) using the resulting one-pack type liquid epoxy resin composition as an adhesive composition. The adhesive composition was coated onto the ferrite sintered body and the coated surface was applied to the metal plate followed by curing for 1 hour at 150° C. Following curing, observation of the ferrite sintered body revealed the absence of the formation of cracks or other defects, and the ferrite sintered body was found to be securely joined to the metal plate.

In addition, for the sake of comparison, 20 parts by weight of PN23 curing agent manufactured by Ajinomoto Co., Inc. and 2 parts by weight of an anti-settling agent in the form of A200 Fine Silica Particles (Nippon Aerosil Co., Ltd.) were added to DGEBA Epoxy (EPON 828), i.e., an ordinary epoxy having a rigid skeleton, manufactured by Hexion Specialty Chemicals, followed by stirring well with a propeller mixer. When a sintered body was adhered in the same manner as described above using this kneaded adhesive composition, cracks were observed to have formed.

This is thought to be the result of the cured product obtained following curing of the epoxy adhesive composition of the present disclosure not imparting stress to the thin, small sintered body due to the flexibility thereof.

### Examples 2 to 8

Epoxy resin compositions were produced and tested in the same manner as

Example 1 using the materials and composition ratios shown in Tables 1 and 2. Those results are shown in Table 2.

When testing was carried out in the same manner as described in “7. Sintered Body Adhesive Strength Test” of Example 1, cracks did not form in any of Examples 2 to 8.

### Comparative Example 1

An epoxy resin composition was produced and tested in the same manner as Example 1 using the materials and composition ratios shown in Tables 1 and 2. Those results are shown in Table 2.

TABLE 1

| | Product | | Raw Material | Raw Material Supplementary |
|---|---|---|---|---|
| | Name, etc. | Generic Name | Manufacturer | Information |
| Epoxy resin | L207 | Epoxidated butadiene- | Kuraray | Liquid epoxy, epoxy |
| | | isoprene polymer | | equivalent(EEW): 590 |
| Reactive diluent | YD-171 | Dimer acid diglycidyl ester | Tohto Kasei | Liquid epoxy, EEW: |
| | | | | 390-470 |
| | Denarex R- | Glycidyl ether-terminated | Nagase | Liquid epoxy, (EEW): 1570 |
| | 45EPT | polybutadiene | | |
| | OXT-212 | Monofunctional oxetane | Toagosei | Low viscosity liquid |
| | | resin | | |
| | DY-A | Monofunctional epoxy resin | Huntsman | 2-ethylhexyl |
| | | having a long-chain alkyl | | glycidyl ester |
| | | group | | |
| | Pripol 2023 | Dimer diol | Croda Japan | C36, fatty acid diol |
| Curing agent | DDSA | Dodecenyl succinic | New Japan | Liquid acid anhydride |
| | | anhydride | Chemical | |
| | B-4400 | Tetrabasic acid anhydride | DIC | Solid acid anhydride |
| | TMEG-600 | Tetrabasic acid anhydride | New Japan | Solid acid anhydride |
| | | | Chemical | |
| Curing accelerator | Zinc | Zinc stearate | Sakai Chemical | White powder |
| | stearate | | Industry | |
| | LCAT-No1 | Organic zinc compound | NOF | Clear liquid |
| | Al acac | Aluminum acetyl acetonate | Nihon Kagaku | White powder |
| | | | Sangyo | |
| Inorganic filler | TS720 | Fine silica particles | Cabot | particle diameter: approx. 10 nm |
| | UFP-30 | Fine silica particles | Denka | particle diameter: 99 nm |
| | UFP-80 | Fine silica particles | Denka | particle diameter: 34 nm |
| | AW4074 | Alumina | Micron | particle diameter: 40 μm |
| | L44 | Silica | Denka | particle diameter: 44 μm |
| Other additives | A-187 | Silica coupling agent | Dow Corning | Low viscosity liquid |
| | | | Toray | |
| | BYK-052 | Antifoaming agent | BYK-Chemie | Low viscosity liquid |
| | | | Japan | |

TABLE 2

| | | | | | | | | | | Comp. |
|---|---|---|---|---|---|---|---|---|---|---|
| | | Examples | | | | | | | | Ex. |
| | | 1 | 2 | 3 | 4 | 5 | 6 | 7 | 8 | 1 |
| L207 | | 100 | 100 | 100 | 100 | 100 | 100 | 100 | 100 | 100 |
| YD-171 | | 25 | 25 | 25 | 25 | 25 | | 25 | | |
| Denarex R-45EPT | | | | | | | 10 | | | |
| OXT-212 | | 12.5 | | | 12.5 | 12.5 | 10 | | | |
| DY-A | | | 12.5 | 12.5 | | | | | | |
| Pripol 2023 | | 25 | 25 | 25 | 25 | 25 | 20 | 25 | 20 | 20 |
| DDSA | | | | | | | | | | 25 |
| B-4400 | | 30 | 30 | | 30 | 30 | 16 | 25 | 15 | |
| TMEG-600 | | | | 45 | | | | | | |
| Zinc stearate | | 2.5 | 2.5 | 2.5 | | | 1 | 1.88 | 1 | 1.5 |
| LCAT-No1 | | | | | 2.5 | | | | | |
| Al acac | | | | | | 2.5 | | | | |
| TS720 | | | | | | | 2 | 2.5 | 2 | |
| UFP-80 | | 50 | 50 | 50 | 50 | | | | | |
| UFP-30 | | | | | | 50 | | | | |
| AW4074 | | | | | | | 40 | 62.5 | | |
| L44 | | | | | | | | | | 10 |
| A-187 | | 2.5 | 2.5 | 2.5 | 2.5 | 2.5 | 3 | 3.75 | 2 | |
| BYK-052 | | | | | 0.125 | 0.125 | 0.1 | 0.125 | | 0.1 |
| Shear | 25° C. | 4.8 | 6.0 | 5.5 | 5.2 | 5.0 | 1.5 | 2.6 | 1.4 | 1.5 |
| adhesive | 120° C. | 2.2 | 2.3 | 2.3 | 2.0 | 2.1 | 0.3 | 0.6 | 0.3 | 0.2 |
| strength | | | | | | | | | | |
| (MPa)*¹ | | | | | | | | | | |

| | | | | | | | | | |
|---|---|---|---|---|---|---|---|---|---|
| Elongation | 170% | 170% | 170% | 170% | 170% | 200% | — | — | 200% |
| percentage*¹ | | | | | | | | | |
| Pressure cooker test | 6.3 | 4.7 | 5.7 | 4.4 | 4.2 | 2.7 | 4.7 | — | — |
| (MPa)*¹ | | | | | | | | | |
| (134° C., 100% RH, | | | | | | | | | |
| 24 h) | | | | | | | | | |
| Workable period | 2 wk | 2 wk | 2 wk | 2 wk | 2 wk | 2 wk | 2 wk | 2 wk | <24 h |
| (40° C.)*² | | | | | | | | | |

*¹Cured for 1 hour at 150° C.
*²Time until viscosity reached a value twice that of initial viscosity

The following matters were confirmed based on the results of Table 2. The workable period depends on the type of acid anhydride. The workable periods of the examples were 2 weeks, which is longer than that of the comparative example. This is thought to be due to the acid anhydride curing agents (B-4400 and TMEG-600) used in the examples being solids at room temperature in contrast to the acid anhydride curing agent (DDSA) used in the comparative example being a liquid at room temperature.

In addition, based on the results of the examples, the glass transition temperatures (Tg) of the cured products were low, and the examples demonstrated elastomer properties and high elongation percentages. As a result, they are able to alleviate stress on adhered materials at low temperatures, and even in cases in which the adhered material is susceptible to cracking such as a sintered body (for example, various types of magnets, and ferrite for transformer), the formation of cracks can be inhibited. In addition, since the chlorine content of the examples is low, they are able to satisfy low halogen requirements. Moreover, in addition to allowing the obtaining of adequate adhesive strength with respect to shear adhesive strength, Examples 1 to 5, which contain an inorganic filler having a particle diameter of 1 μm or less, maintained high values for adhesive strength at 120° C. Moreover, durability of the resulting cured products was confirmed based on the results of the pressure cooker test.

1. A one-pack type liquid epoxy resin composition, comprising:
a polyfunctional linear epoxy resin having an epoxy equivalent of 400 or more;
a tetrabasic acid anhydride having a melting point of 10° C. or higher; and
an organic metal compound.

2. The one-pack type liquid epoxy resin composition according to claim 1, wherein the epoxy equivalent of the polyfunctional linear epoxy resin is 2000 or less.

3. The one-pack type liquid epoxy resin composition according to claim 1, wherein the polyfunctional linear epoxy resin has for a main chain thereof a unit derived from a polymerizable hydrocarbon compound having carbon-carbon multiple bonds, and has two or more epoxy rings.

4. The one-pack type liquid epoxy resin composition according to claim 3, wherein the polyfunctional linear epoxy resin is obtained by epoxidating double bonds within a linear unsaturated hydrocarbon chain.

5. The one-pack type liquid epoxy resin composition according to claim 1, further comprising a reactive diluent.

6. The one-pack type liquid epoxy resin composition according claim 1, further comprising an inorganic filler.

7. The one-pack type liquid epoxy resin composition according to claim 6, wherein a particle diameter of the inorganic filler is less than about 1 μm.

8. The one-pack type liquid epoxy resin composition according to claim 1, wherein the tetrabasic acid anhydride constitutes about 10 to about 50 parts by weight and the organic metal compound constitutes about 0.5 to about 10 parts by weight based on 100 parts by weight of the polyfunctional linear epoxy resin.

9. An epoxy adhesive composition comprising the one-pack type liquid epoxy resin composition according to claim 1.

10. An article in which a brittle material is adhered to an adhered material by means of a cured product of the epoxy adhesive composition according to claim 9.

11. A production method of an adhered article, comprising:
coating the epoxy adhesive composition according to claim 9 onto a brittle material or adhered material;
joining the brittle material and the adhered material by means of the epoxy adhesive composition; and
curing the epoxy adhesive composition.
